(19) United States
(12) Patent Application Publication
(10) Pub. No.: US 2023/0406771 A1
(43) Pub. Date: Dec. 21, 2023

(54) SCREENING MASK, PATTERN MOLD, METHOD FOR MANUFACTURING ARTIFICIAL MARBLE, AND ARTIFICIAL MARBLE

(71) Applicant: LX HAUSYS, LTD., Seoul (KR)

(72) Inventors: Yechan KIM, Seoul (KR); Donghee KIM, Seoul (KR); Junyoung SEO, Seoul (KR); Bonho KOO, Seoul (KR); Hongkwan CHO, Seoul (KR)

(21) Appl. No.: 18/250,367

(22) PCT Filed: Nov. 26, 2021
(86) PCT No.: PCT/KR2021/017682

§ 371 Date: Apr. 25, 2023

(30) Foreign Application Priority Data
Nov. 27, 2020 (KR) 10-2020-0163210
Dec. 22, 2020 (KR) 10-2020-0181400

(51) Int. Cl. C04B 26/18; C04B 14/06; C04B 18/14; C04B 41/45; C04B 41/00; C04B 41/48; C04B 41/63; B44F 9/04; B28B 1/00; B28B 1/08; B28B 17/00

(52) U.S. Cl. CPC C04B 26/18; C04B 14/06; C04B 18/146; C04B 41/4578; C04B 41/4509; C04B 41/4576; C04B 41/0072; C04B 41/4826; C04B 41/63; B44F 9/04; B28B 1/005; B28B 1/08; B28B 17/0036; C04B 2103/54

(57) ABSTRACT

The present invention relates to an artificial marble and a manufacturing method of an artificial marble. In addition, the present invention relates to a screening mask and a pattern mold for manufacturing the artificial marble.

### TECHNICAL FIELD

This application claims priority to and the benefit of Korean Patent Application No. 10-2020-0181400 filed in the Korean Intellectual Property Office on Dec. 22, 2020, the entire contents of which are incorporated herein by reference.

The present invention relates to a screening mask, a pattern mold, a manufacturing method of an artificial marble using the same, and an artificial marble.

### BACKGROUND ART

Engineered stone is artificial marble, also called E-stone, and is an interior design material that has a texture and feel similar to those of natural stone. In the industries, researches have been made to enhance an aesthetic sense by improving color-development, shape and the like of artificial marble. For example, Korean Patent No. 10-1270415 discloses an artificial marble with various patterns and appearances using marble chips. Demand for engineered stone is gradually increasing for interior floors, wall decorations, and kitchen worktops, and most of the products imitate natural stone species such as granite and marble.

However, in the recent interior design market, interest in natural stones having sharp veins, such as quartzite, is gradually increasing. Reflecting this trend, the E-stone industry is also making significant efforts to implement the design of natural stones.

However, it is not easy to implement the design of natural stones with the current E-stone production technology. In the existing E-stone production process, a flow pattern is expressed by spraying a pigment on a surface of a base composition, or a pattern is expressed by removing certain portions of a base composition with a knife or the like and then filling the same with other raw materials. However, this method causes a large sense of discrepancy, as compared with the actual natural stone.

### DETAILED DESCRIPTION OF THE INVENTION

### Technical Problem

An object of the present invention is to provide an artificial marble having a clear boundary between a pattern region and a base region and a wide stripe region, and a method for manufacturing the same.

Another object of the present invention is to provide a screening mask and a pattern mold used in the manufacturing method of the artificial marble.

### Technical Solution

In order to achieve the above object, an exemplary embodiment of the present invention provides an engineered stone artificial marble including a base and a pattern provided in the base, in which the pattern includes a vein pattern, in which 50% or more of the vein pattern has a width of 5 mm to 50 mm on a surface where the vein pattern is most present of surfaces of the artificial marble, and in which in a cross section including a maximum thickness of the vein pattern among cross sections in a direction perpendicular to a plate surface of the artificial marble, an area of the vein pattern in which a thickness of the vein pattern is 10% or greater of a total thickness of the artificial marble is 50% or greater of an area of the entire pattern.

An exemplary embodiment of the present invention provides an engineered stone artificial marble including a base and a pattern provided in the base, in which the pattern includes a vein pattern, and in which when an arbitrary square region is equally divided into 20×20 surfaces on a surface where the vein pattern is most present among surfaces of the artificial marble and then a straight line traversing the vein pattern in a width direction and having both ends located on the base is drawn, or if it is not possible to draw a straight line whose both ends are located on the base, a straight line with one end on the base and the other end on the vein pattern is drawn, an area of divided surfaces having a vein pattern having two or more peaks on a graph of 5-section moving average values of a gray value measured along the straight line is less than 30% of an area excluding the divided surfaces, on which only the vein pattern is present or only the base is present, in the square region.

Another exemplary embodiment of the present invention provides an engineered stone artificial marble including a first region formed by first distribution on a surface and a second region formed by second distribution after the first distribution, in which the first region and the second region are different in composition from each other, and the first region and the second region are not substantially mixed.

Still another exemplary embodiment of the present invention provides a screening mask including a flat plate portion and one or more openings.

Yet another embodiment of the present invention provides a pattern mold including a concave portion and one or more convex portions, in which the convex portions correspond to openings of a screening mask and are insertable into the openings.

Still yet another exemplary embodiment of the present invention provides a manufacturing method of an artificial marble including molding a base composition into a mold; placing a screening mask and a pattern mold over the base composition, the screening mask including a flat plate portion and one or more openings, the pattern mold including a concave portion and one or more convex portions, the convex portions corresponding to the openings of the screening mask and being insertable into the openings; pressing the pattern mold to compress the base composition; removing the pattern mold to form one or more grooves in the base composition; putting a pattern forming composition into the grooves and removing the screening mask; manufacturing an artificial marble flat plate by compressing the composition in the mold while applying vacuum and vibration to the composition; and applying heat to the artificial marble flat plate before curing, and curing the artificial marble flat plate.

A further exemplary embodiment of the present invention provides an artificial marble including a pattern region and a base region and manufactured by the manufacturing method of an artificial marble according to the above-described embodiments.

### Advantageous Effects

The artificial marble manufactured using the screening mask and the pattern mold of the present invention includes the pattern region and the base region, and a boundary between the pattern region and the base region is clear and a width of the pattern region is wide.

### BRIEF DESCRIPTION OF DRAWINGS

FIG. 1 shows a cross-section of a part of one type of a screening mask 200 of the present invention.

FIG. 2 shows a cross-section of a part of one type of a pattern mold 100 of the present invention.

FIG. 3 is a cross-sectional view showing that the pattern mold 100 is stacked on the screening mask 200 and a convex portion of the pattern mold is inserted into an opening of the screening mask.

FIG. 4 is a photograph showing an example of a pattern mold of the present invention.

FIG. 5 is a photograph showing an example of a screening mask of the present invention.

FIG. 6 shows a process of manufacturing an artificial marble by using the screening mask and the pattern mold of the present invention.

FIG. 7 shows an insert mold used in Comparative Example 2.

FIG. 8 shows a process for manufacturing an artificial marble by using the insert mold of Comparative Example 2.

FIG. 9 shows a manufacturing process of an artificial marble sample of Comparative Example 1.

FIG. 10 shows a manufacturing process of an artificial marble sample of Example 1.

FIG. 11 is a graph of 5-section moving average values of a gray value measured in a vein pattern on a surface of the artificial marble of Example 1.

FIG. 12 is a graph of 5-section moving average values of a gray value measured in a vein pattern on a surface of an artificial marble of a control.

FIGS. 13 and 14 show a process of measuring a gray value so as to derive the results of FIGS. 11 and 12, respectively.

FIG. 15 shows a width (W), a length (L), and a center line (C) of the vein pattern on the surface of the artificial marble of Example 1.

FIG. 16 shows an example of measuring the thickness of the vein pattern of the artificial marble of Example 1.

FIG. 17 shows top surface photographs of artificial marbles manufactured in Example 1 (left photograph) and Comparative Example 3 (right photograph).

FIG. 18 shows a part having a clear boundary with a base by a short dotted line and shows a part having a disordered boundary by a long dotted line in the photograph of FIG. 17.

FIG. 19 shows 20×20 divided surfaces of the photograph of FIG. 17.

FIG. 20 shows virtual lines drawn on effective divided surfaces excluding divided surfaces where only a base or vein pattern is present in FIG. 19.

FIG. 21 is a graph of 5-section moving average values of a gray value measured along the virtual straight lines of divided surfaces A, B, C and D in FIG. 20.

FIG. 22 marks, among the effective divided surfaces in FIG. 20, a divided surface on which two or more peaks appear as described above with 1.

### BEST MODE

Hereinafter, exemplary embodiments of the present application will be described in detail. However, the following descriptions are provided to exemplify the above embodiments, not to limit the scope of the present invention.

The terms or words used throughout the specification and the claims should not be construed as being limited to their ordinary or dictionary meanings, but construed as having meanings and concepts consistent with the technical idea of the present invention, based on the principle that an inventor may properly define the concepts of the words or terms to best explain the invention.

The terms used in the present specification are merely used to describe various exemplary embodiments of the present invention but are not intended to limit the present invention. The singular forms “a”, “an” and “the” are intended to include plural forms as well, unless the context clearly indicates otherwise.

In the present specification, it should be understood that terms such as “include”, “comprise” or “have” are used to describe the presence of a specific component, and do not exclude the presence or possibility of addition of other components.

In the present specification, the expression “existing on” a specific component is intended to express “existing on one side” of a specific component, and is not intended to limit an upper-lower relationship, and is not also limited to being in physical contact with the component but means that another member may be additionally provided between the components.

In the present specification, “pattern” or “pattern region” is an expression distinct from an entire surface layer, and unlike the entire surface layer in which a specific material occupies the entire volume of one layer, means that a specific material occupies only a part of a volume of one layer, and a part of the corresponding layer is an empty space or is filled with another material.

In the present specification, “base” or “base region” means a base part other than a pattern in an artificial marble.

In the present specification, a vein pattern means a pattern resembling a vein or a tree branch, and means a pattern that is continued to have a certain length or longer. In the present specification, the vein pattern is not limited to a straight line or a specific curved line. In the present specification, the vein pattern may also be referred to as a stripe pattern.

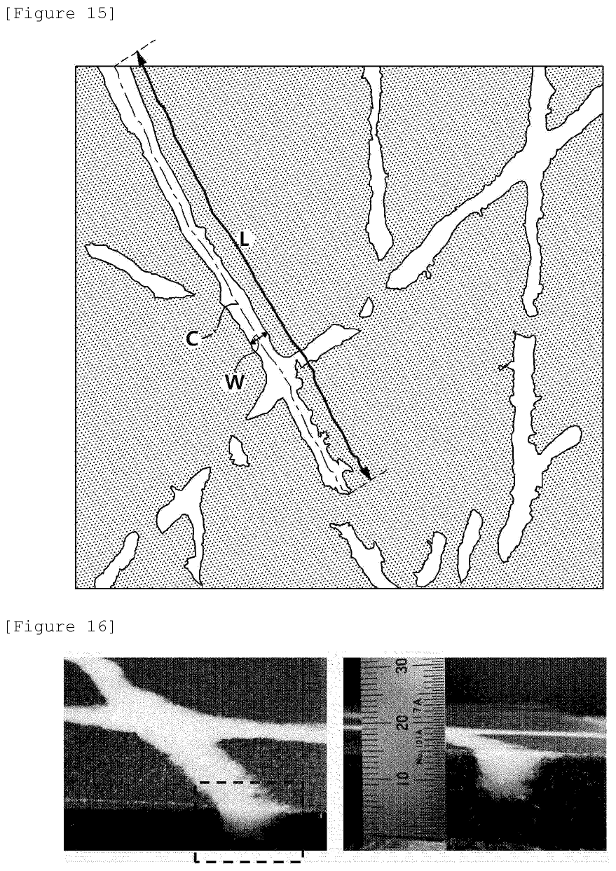

In the present specification, a width of the pattern or pattern region means a distance between two facing points at which, when a center line is drawn on a pattern observed on a surface or side of an artificial marble, a line perpendicular to a slope at a center point to be measured intersects edges of the pattern. Here, the center line means a line drawn by connecting points at which the shortest distances among distances from the center line to the edge of the pattern are the same. In other words, the center line means a line drawn by connecting center points of lines with the shortest distances from an edge of an arbitrary pattern to a facing edge of the pattern. For example, a center line and a width of a pattern are indicated by C and W in FIG. 15, respectively.

In the present specification, a length of the pattern or pattern region means a length of the center line when the center line is drawn on the vein pattern observed on the surface or side surface of the artificial marble. For example, a length of each pattern is indicated by L in FIG. 15.

In the present specification, an area of the pattern means an area occupied by the pattern observed on the surface or side of the artificial marble.

In the present specification, a thickness of the artificial marble means the shortest length between plate surfaces of the artificial marble facing each other.

In the present specification, a thickness of the pattern or pattern region means a length of the pattern in a thickness direction of the artificial marble.

Hereinafter, the present invention will be described in detail.

An exemplary embodiment of the present invention provides an engineered stone artificial marble including a base and a pattern provided in the base, in which the pattern includes a vein pattern, in which 50% or more of the vein pattern has a width of 5 mm to 50 mm on a surface where the vein pattern is most present among surfaces of the artificial marble, and in which in a cross section including a maximum thickness of the vein pattern among cross sections in a direction perpendicular to a plate surface of the artificial marble, an area of the vein pattern in which a thickness of the vein pattern is 10% or greater of a total thickness of the artificial marble is 50% or greater of an area of the entire pattern.

The artificial marble has such a feature that the vein pattern is formed to have a wide width and a relatively thick thickness by being manufactured by the method described later. In the present specification, the surface of the artificial marble means the outermost part of the artificial marble, and includes, for example, two plate surfaces of the artificial marble facing each other, i.e., an upper surface and a lower surface, and side surfaces of the artificial marble. For example, when the artificial marble is a rectangular parallelepiped, the surface of the artificial marble includes an upper surface, a lower surface and four side surfaces. The vein pattern is displayed on at least one of the surfaces of the artificial marble, and may be present only on the upper surface of the artificial marble or on both the upper and lower surfaces of the artificial marble. In an exemplary embodiment, a width of the vein pattern is a value measured on a surface where the vein pattern is most present among the surfaces of the artificial marble.

According to an exemplary embodiment, 80% or more of the vein pattern may have a width of 5 mm to 50 mm on the surface where the vein pattern is most present among the surfaces of the artificial marble.

According to an exemplary embodiment, 80% or more of the vein pattern may have a width of 5 mm to 20 mm on the surface where the vein pattern is most present among the surfaces of the artificial marble.

In the artificial marble according to the exemplary embodiment, the surface where the vein pattern is most present among the surfaces of the artificial marble may include a vein pattern having a continuous length of 50 mm or longer.

In an exemplary embodiment, in a cross section including a maximum thickness of the vein pattern among cross sections in a direction perpendicular to a plate surface of the artificial marble, an area of the vein pattern in which a thickness of the vein pattern is 30% or greater, and preferably, 50% or greater of a total thickness of the artificial marble may be 50% or greater of an area of the entire pattern.

In an exemplary embodiment, the base and the vein pattern are not substantially mixed and a boundary therebetween is clear.

An exemplary embodiment of the present invention provides an engineered stone artificial marble including a base and a pattern provided in the base, in which the pattern includes a vein pattern, and in which when an arbitrary square region is equally divided into 20×20 surfaces on a surface where the vein pattern is most present among surfaces of the artificial marble and then a straight line traversing the vein pattern in a width direction and having both ends located on the base is drawn, or if it is not possible to draw a straight line whose both ends are located on the base, a straight line with one end on the base and the other end on the vein pattern is drawn, an area of divided surfaces having a vein pattern having two or more peaks on a graph of 5-section moving average values of a gray value measured along the straight line is less than 30% of an area excluding the divided surfaces, on which only the vein pattern is present or only the base is present, in the square region.

Among regions with the two or more peaks, one peak is a peak generated when presence of a vein pattern having a color difference from the base is included in the graph, and the other additional peak represents untidiness or the like caused due to substantial spreading of a pattern, deposition of a pigment of the vein pattern into the base, or scattered remnants of the vein pattern composition not neatly filling the vein pattern region. Therefore, although the peak mathematically means an inflection point, a form without an inflection point where a long intermediate ridge line is observed among a base/a vein pattern/a base, which can be understood as a sufficiently disturbed phenomenon by one skilled in the art, should be also interpreted as a substantial peak.

In the exemplary embodiment, a length of the straight line traversing the vein pattern in the width direction and drawn so that both ends are located on the base may be twice the width of the vein pattern. A length of the straight line drawn so that one end is on the base and the other end is on the vein pattern may be the same as the width of the vein pattern.

In the exemplary embodiments, an arbitrary square region may be 30 cm×30 cm, 60 cm×60 cm, or 120 cm×120 cm.

The 5-section moving average value of the gray value is obtained by taking an image of an object to be measured, scanning the taken image, drawing, on the scanned image, a virtual line, i.e., a straight line traversing the vein pattern in a width direction using and having both ends located on a base, or a straight line traversing a boundary between the vein pattern and the base and having one end located on the base and the other end located on the vein pattern, or if it is not possible to draw a straight line whose both ends are located on the base, a straight line having one end located on the base and the other end located on the vein pattern by using a program called ImageJ, graphing gray values to obtain a gray scale for each dot, and using this value. The moving average is an average obtained by moving from one section to another so as to determine change of a trend, and the 5-section moving average value is used in the exemplary embodiments. ImageJ is a Java-based image processing program developed and distributed by the National Institutes of Health (NIH) and the University of Wisconsin LOCI (Laboratory for Optical and Computational Instrumentation), and can be downloaded from https://imagej.nih.gov/. ImageJ can be used depending on how the program is used. For example, 1) after image scanning, 2) a file is opened, 3) a linear selection bar is clicked, 4) a region to be measured in the image, i.e., a region of the base/vein pattern/base or base/vein pattern described above is selected, 5) values are analyzed, a graph (Plot Profile) is drawn, and then the moving average value can be acquired using the data. The gray value can also be expressed as a gray scale, and can be derived by a known method such as the basic formula (R+G+B)/3 or the YUV method (YPbPr, YCbCr, YIQ, etc.). For example, in an exemplary embodiment, the basic formula and (R+G+B)/3 basically provided by ImageJ can be used.

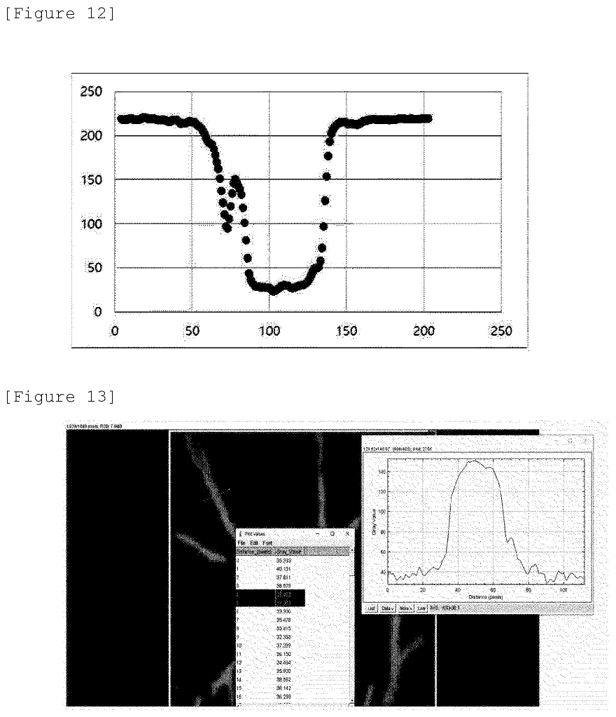

The presence of a peak in the graph of the 5-section moving average values of the gray value means that the boundary between the pattern and the base is not clear. As such, even when a region with an unclear boundary is present, the invention is characterized in that the region is less than 30%. Here, the peak refers to a portion that protrudes upward or downward on the graph, as compared with the other regions. When a color of the vein pattern is deeper than a color of the base, the peak is displayed as a portion protruding downward on the graph. For example, FIG. 12 shows an example in which a peak protrudes downward on the graph. In this case, the lowest point of the peak may be different from the highest point of the graph by 50 or more. However, in the case of a design where a vein pattern and a base color are similar but is distinguished with an eye, the gray value may not differ by 50 or more, so it should be understood as a reference value. When the color of the vein pattern is lighter than the color of the base, the peak is displayed as a portion protruding upward on the graph. In this case, the highest point of the peak may be different from the lowest point of the graph by 50 or more. For example, FIG. 11 shows an example where a peak protrudes downward on the graph. Here, the gray value is a relative value. When the gray value (R/3+G/3+B/3) is 0, it means black, and when the gray value is 255 (R=255, G=255, B=255), it means white. In FIGS. 11 and 12, the vertical axis represents the gray value, and the horizontal axis represents the points where the gray value is measured on the virtual straight line.

Another exemplary embodiment of the present invention provides an engineered stone artificial marble including a first region formed by first distribution on a surface and a second region formed by second distribution after the first distribution, in which the first region and the second region are different in composition from each other, and the first region and the second region are not substantially mixed. Here, the composition may include at least one of types of compounds included in the first and second regions, a size of a particle, a distribution of constituent particles, an additive, chromaticity, or a sense of color. The artificial marble may have a characteristic that the first region and the second region are not substantially mixed by using a method of compressing a base composition by using a screening mask and a pattern mold according to a method described below.

<Screening Mask>

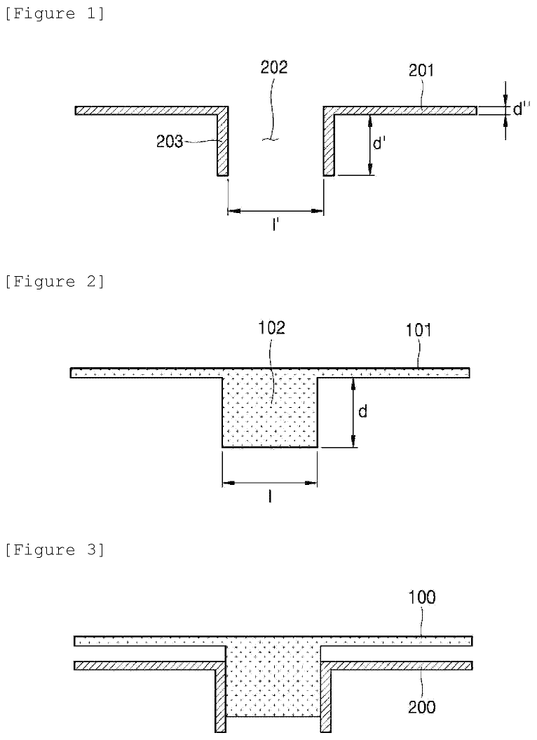

FIG. 1 shows a cross-section of a part of one type of a screening mask of the present invention (a configuration of the screening mask behind the cut-out part is not shown). In FIG. 1, a case in which there is only one opening is enlarged and shown. A screening mask 200 of the present invention includes a flat plate portion 201 and one or more openings 202 formed on the flat plate portion 201. The screening mask of the present invention may further include a protrusion 203 protruding from an edge of the opening along a shape of the opening. Here, the beginning of the protrusion is the same as an outer circumferential surface of the opening, but the end of the protrusion may not match the shape of the outer circumferential surface of the opening. The protrusion may have a form of protruding in a direction perpendicular to a plate surface of the flat plate portion, may have a form in which a distance between the protrusions decreases as a distance from the plate surface of the flat plate portion increases, or may have a form in which ends of the protrusions converge with each other. However, since the screening mask must be ultimately removed, if the protrusions extremely converge with each other, the screening mask may not be suitable for a neat pattern. Therefore, the most suitable case is that the protrusion is formed in the direction perpendicular to the plate surface of the flat plate portion and the shape of the outer circumferential surface at the end of the protrusion coincides with that of the outer circumferential surface at the beginning of the protrusion.

The flat plate portion may correspond to a concave portion of the pattern mold. When the screening mask and the pattern mold are sequentially stacked on the base composition and the pattern mold is pressed, the base composition is compressed. In this case, a part of the base composition that is pressed against the flat plate portion of the screening mask is also compressed.

A thickness (d″) of the flat plate portion is not particularly limited, and one skilled in the art may appropriately select it in consideration of a material of the screening mask, a size of the screening mask, and the like.

The opening corresponds to a convex portion of the pattern mold, and the convex portion is inserted into the opening. A width (1′) of the opening may be equal to or greater than a width (1) of the convex portion. In an exemplary embodiment of the present invention, the width (1′) of the opening may be 0.1 mm to 5 mm, preferably 0.1 mm to 3 mm larger than the width (1) of the convex portion.

A length (d′) of the protrusion may be equal to or smaller than the thickness of the artificial marble. For example, when the thickness of the artificial marble is 5 cm, the length of the protrusion may be 3 mm to 5 cm. The length (d′) of the protrusion may be 1 to 100% of the thickness of the artificial marble, preferably 1% or greater and 80% or less, and more preferably 1% or greater and 70% or less, and one skilled in the art can appropriately select the same in consideration of a depth and shape of a pattern region to be formed on the artificial marble, a composition of the pattern region, a composition of a base composition, and the like.

<Pattern Mold>

FIG. 2 shows a cross-section of a part of one type of a pattern mold 100 of the present invention. In FIG. 2, a case in which there is only one convex portion is enlarged and shown. The pattern mold 100 of the present invention includes a concave portion 101 and one or more convex portions 102.

The convex portion corresponds to the opening of the screening mask and is insertable into the opening. The width (1) of the convex portion may be equal to or smaller than the width (1′) of the opening. The width of the convex portion may be 5 mm or greater and 50 mm or less, preferably 5 mm or greater and 40 mm or less, and more preferably 5 mm or greater and 30 mm or less. However, it will be apparent that it is possible to form the pattern mold so that the width of the convex portion of the pattern mold is less than 5 mm or greater than 50 mm. One skilled in the art may adjust the width of the convex portion of the pattern mold according to the desired width of the pattern region of the artificial marble. However, a predetermined width of plastic is required to form the protrusion 203 of the screening mask, and a fixed empty space is necessarily generated during a screening mask removal process by twice the width (on both sides). If the width is less than 5 mm, the empty space becomes significant as compared with a vein region to be actually formed, so that the vein pattern may be focused toward the empty space and may be disordered during the screening mask removal. In addition, although the present invention does not have a big problem in forming a pattern with a width of greater than 50 mm, the width of the convex portion of 50 mm or less may be more suitable because a digging-filling process of filling a base, digging out a portion where a vein pattern is to be formed, and filling the same with a vein component is relatively efficient and inexpensive.

One skilled in the art may appropriately select the width of the convex portion in consideration of the depth, shape, composition of the pattern region to be formed on the artificial marble, the composition of the base composition of the pattern region, and the like.

The thickness (i.e., depth) of the pattern region of the artificial marble may be formed by a value obtained by subtracting the thickness (d″) of the flat plate portion from the length (d) of the convex portion. That is, in the manufacturing process of the artificial marble of the present invention, a groove is formed on the base composition. In this case, a depth of the groove may be a value obtained by subtracting the thickness of the flat plate portion from the length of the convex portion.

In addition, the value obtained by subtracting the thickness of the flat plate portion from the length of the convex portion may be equal to or smaller than the thickness of the artificial marble. In addition, the value obtained by subtracting the thickness of the flat plate portion from the length of the convex portion may be 1% or greater and 100% or less, preferably 1% or greater and 80% or less, and more preferably 1% or greater and 70% or less of the thickness of the artificial marble. When the value obtained by subtracting the thickness of the flat plate portion from the length of the convex portion is 100% of the thickness of the artificial marble, a pattern region extending from one surface of the artificial marble to the opposite surface may be formed.

In addition, the value obtained by subtracting the thickness of the flat plate portion from the length of the convex portion may be equal to or smaller than the length of the protrusion of the screening mask.

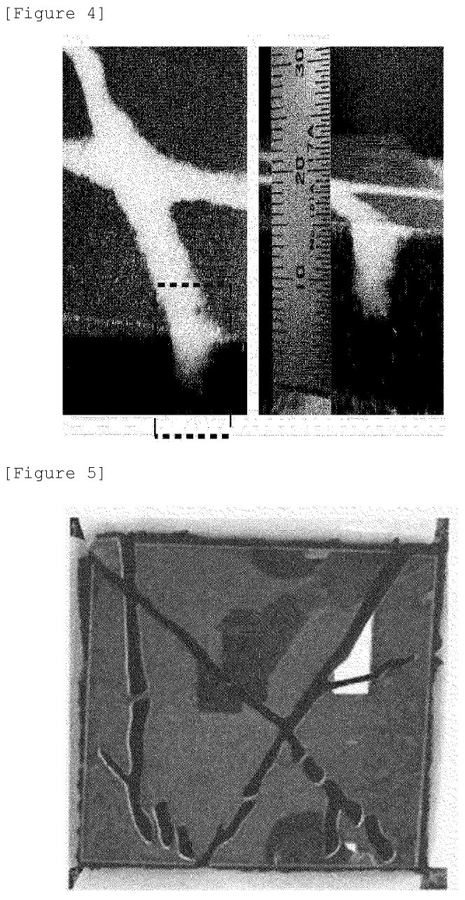

FIG. 3 is a cross-sectional view showing that the pattern mold 100 is stacked on the screening mask 200 and a convex portion of the pattern mold is inserted into an opening of the screening mask. The flat plate portion of the screening mask may be in contact with the concave portion of the pattern mold, and the opening of the screening mask may be in contact with the convex portion of the pattern mold.

FIG. 4 is a photograph showing an example of a pattern mold of the present invention. A plurality of convex portions are formed in various directions and in various shapes, and some convex portions extend to the edges of the pattern mold and some convex portions do not extend to the edges of the pattern mold. The widths (1) and the lengths (d) of the convex portions may be different from each other, and the lengths of the convex portions extending along the concave portion of the pattern mold may also be different. It will be readily understood that the length of the convex portion and the shape of the convex portion can be appropriately selected by one skilled in the art.

FIG. 5 is a photograph showing an example of a screening mask of the present invention. A plurality of openings are formed in various directions and in various shapes, and some openings extend to the edges of the screening mask and some openings do not extend to the edges of the screening mask. It will be readily understood that the openings correspond to the convex portions of the pattern mold and the shapes of the convex portions and openings can be appropriately selected by one skilled in the art.

<Manufacturing Method of Artificial Marble>

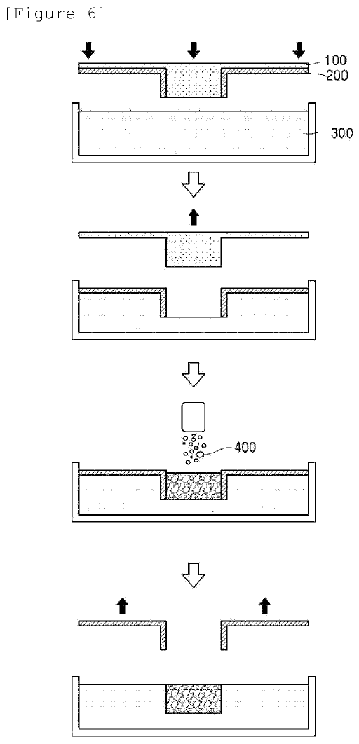

The present invention relates to a manufacturing method of an artificial marble including: molding a base composition into a mold; placing a screening mask 200 and a pattern mold 100 over the base composition 300; pressing the pattern mold to compress the base composition; removing the pattern mold to form one or more grooves in the base composition; putting a pattern forming composition 400 into the grooves and removing the screening mask; manufacturing an artificial marble flat plate by compressing the composition in the mold while applying vacuum and vibration to the composition; and applying heat to the artificial marble flat plate before curing, and curing the artificial marble flat plate (FIG. 6).

Molding Base Composition into Mold

The manufacturing method of an artificial marble of the present invention includes molding a base composition into a mold. The molding is a step of putting the base composition into the mold. The mold may be a general mold that is used in the manufacture of an artificial marble and is not particularly limited.

Placing Screening Mask and Pattern Mold Over Base Composition

The manufacturing method of an artificial marble of the present invention includes placing a screening mask and a pattern mold on the base composition. In this case, the base composition, the screening mask, and the pattern mold are stacked in this order, and the protrusions of the pattern mold are inserted into the openings of the screening mask.

Pressing Pattern Mold to Compress Base Composition

The manufacturing method of an artificial marble of the present invention includes pressing the pattern mold to compress the base composition. Pressing the pattern mold transfers pressure to the base composition. For example, when pressure is applied to the pattern mold, the pressure can be transferred to the base composition in contact with the convex portions of the pattern mold and the base composition in contact with the flat plate portion of the screening mask. By the pressure transferred in this way, the base composition is compressed into a compacted state. While a density of the base composition increases in the portion pressurized by the pressure transferred in this way, the base composition may be pushed aside. In this case, the manufacturing method of an artificial marble of the present invention may include compressing the composition in the mold while applying vacuum and vibration to the composition in the step of pressing the pattern mold to compress the base composition. In this case, the density of the base composition in the final artificial marble becomes uniform by vacuum compaction. The compressing may be expressed as a press method. By compacting the base composition while pressing the mold by the compressing, a vein pattern is not significantly collapsed even when a vibration-compression-vacuum process described later is performed while filling a pattern forming composition in a process to be described later. On the other hand, according to the conventional digging-filling method, it is difficult to sufficiently compact the base composition because the base composition is removed by simply digging out the base composition without the compressing, i.e., the pressing process.

The base composition is pressed and moved aside as much as the convex portions of the pattern mold, and the convex portions are positioned at places where the base composition is moved out.

Removing Pattern Mold to Form One or More Grooves in Base Composition

The manufacturing method of an artificial marble of the present invention includes removing the pattern mold to form one or more grooves in the base composition. When the pattern mold is removed, the screening mask is left on the compressed base composition. Then, a groove is formed in the base composition at the places where the convex portions of the pattern mold were positioned. Since the pressure was applied to the pattern mold, the base composition was compressed, so there is a low possibility that the base composition will penetrate into the groove formed in the base composition.

A depth of the groove may be a value obtained by subtracting the thickness (d″) of the flat plate portion of the screening mask from the length (d) of the convex portion of the pattern mold. A width of the groove may be equal to or greater than the width (1) of the convex portion of the pattern mold.

Putting Pattern Forming Composition Into Grooves and Removing Screening Mask

The manufacturing method of an artificial marble of the present invention includes putting a pattern forming composition into the grooves and removing the screening mask. Since the base composition is in a compressed state even when the screening mask is removed, the pattern forming composition remains in the grooves without intruding into the base composition.

Manufacturing Artificial Marble Flat Plate by Compressing Composition in Mold while Applying Vacuum and Vibration to Composition

The manufacturing method of an artificial marble of the present includes manufacturing an artificial marble flat plate by compressing the composition in the mold while applying vacuum and vibration to the composition. The above step may be performed using a vibration-compression-vacuum process.

In the present invention, since the base composition was compressed using the screening mask and the pattern mold, mixing and/or overlapping of the base composition and the pattern forming composition do not occur even when the vibration-compression-vacuum process is performed.

The vibration-compression-vacuum process may be performed for 1 minute to 5 minutes under a vibration condition of 2000 rpm to 5000 rpm at a degree of vacuum of 1 mbar to 20 mbar. The degree of vacuum may be 5 mbar to 18 mbar or 10 mbar to 15 mbar. The vibration speed may be 2500 rpm to 4500 rpm or 3000 rpm to 4000 rpm. The performing time of the vibration-compression-vacuum process may be 2 to 4 minutes. By performing the vibration-compression-vacuum process under the above conditions, an artificial marble composition compressed into a flat plate, i.e., an artificial marble flat plate can be manufactured, and then cured to manufacture an artificial marble.

Applying Heat to Artificial Marble Flat Plate Before Curing, and Curing Artificial Marble Flat Plate

The manufacturing method of an artificial marble of the present invention includes applying heat to the artificial marble flat plate before curing, and curing the artificial marble flat plate. The curing may be performed using a general curing process that is performed in the manufacture of an artificial marble, and is not particularly limited.

In the present invention, since the base composition was compressed using the screening mask and the pattern mold, mixing and/or overlapping of the base composition and the pattern forming composition do not occur even when the vibration-compression-vacuum process is performed.

Therefore, in the artificial marble manufactured by the manufacturing method of the present invention, a boundary between the base region where the base composition is cured and the pattern region where the pattern forming composition is cured is clear and has a sharp and straight shape.

The curing may be performed by curing the artificial marble composition at 90 to 130° C. for 30 minutes to 1 hour, cooling the composition to room temperature after the curing is completed, and then removing (demolding) the composition from the mold.

Base Composition and Pattern Forming Composition

The base composition and/or the pattern formation composition of the present invention may be a composition that is used for engineered stones, and is not particularly limited. One skilled in the art may appropriately select a base composition and a pattern forming composition according to desired physical properties and aesthetic sense of an artificial marble.

For example, the base composition and/or pattern forming composition of the present invention may include 500 to 700 parts by weight of inorganic particles and 200 to 400 parts by weight of quartz powder on the basis of 100 parts by weight of a binder resin, and the binder resin may include 90% by weight or more of an unsaturated polyester resin. In this case, the base composition and/or the pattern forming composition of the present invention may further include 0 to 20 parts by weight, and preferably 0 part by weight or more and 15 parts by weight or less of a pigment on the basis of 100 parts by weight of the binder resin. That is, at least one of the base composition or the pattern formation composition of the present invention may not include a pigment. In addition, both the base composition and the pattern forming composition of the present invention may also include a pigment.

As for the base composition, a first sub-base composition is prepared by mixing inorganic particles with a binder resin composition, mixing the mixture well, and mixing quartz powder, a pigment and/or chips with the mixture, a second sub-base composition is prepared in the same way while using different types of a pigment and/or chip, and a plurality of, for example, two or more sub-base compositions are prepared in a small amount in this way and then mixed to manufacture a final base composition.

Each of the sub-base compositions may include different pigments and/or chips, and addition amounts of each of the sub-base compositions used in the manufacture of the base composition may also be different. In addition, when manufacturing a final base composition by mixing a plurality of sub-base compositions, the mixing is preferably incompletely performed in such a manner that the sub-base compositions are not completely mixed with each other and the sub-base compositions remain lumped in places in the final base composition.

When an artificial marble is manufactured by incompletely mixing a plurality of sub-base compositions to manufacture a final base composition, the first used sub-base composition remains lumped in places in the base region of the artificial marble, and the lumped portions give the artificial marble with a special aesthetic sense.

Binder Resin

The artificial marble and/or the region of the artificial marble of the present invention includes a binder resin.

The binder resin is a binder resin including an unsaturated polyester (UPE) resin. The binder resin may include the unsaturated polyester resin in an amount of 90% by weight or more.

The binder resin may be manufactured by mixing, dispersing, and curing 0.4 to 2.5 parts by weight of a curing agent, 0.05 to 0.3 part by weight of a catalyst, and 0.5 to 7 parts by weight of a coupling agent on the basis of 100 parts by weight of the unsaturated polyester resin.

The unsaturated polyester resin may be manufactured using a resin mixture including an unsaturated polyester polymer and a vinylic monomer. Preferably, the unsaturated polyester resin is manufactured using a composition including an unsaturated polyester polymer and a vinylic monomer in a weight ratio of 100:30 to 70. More preferably, the unsaturated polyester resin is manufactured using a composition including 60% by weight to 75% by weight of the unsaturated polyester polymer and 25% by weight to 40% by weight of the vinylic monomer.

The unsaturated polyester resin may be typically a viscous solution in which the unsaturated polyester polymer is diluted in the vinylic monomer. Therefore, when the content of the vinylic monomer is included within the range described above, the viscosity can be reduced, making it easier to handle the unsaturated polyester resin. Furthermore, the vinylic monomer can cure the unsaturated polyester resin from liquid to solid through cross-linking of polyester molecular chains without generating by-products. A weight-average molecular weight of the unsaturated polyester resin is 1,000 to 10,000 g/mol.

The unsaturated polyester polymer is not particularly limited, and examples thereof may include an unsaturated polyester polymer manufactured through a condensation reaction of a saturated or unsaturated dibasic acid and a polyhydric alcohol. Examples of the saturated or unsaturated dibasic acid may include ortho-phthalic acid, isophthalic acid, maleic anhydride, citraconic acid, fumaric acid, itaconic acid, phthalic acid, phthalic anhydride, terephthalic acid, succinic acid, adipic acid, sebacic acid or tetrahydrophthalic acid. In addition, examples of the polyhydric alcohol may include ethylene glycol, diethylene glycol, triethylene glycol, propylene glycol, dipropylene glycol, tripropylene glycol, polypropylene glycol, 1,3-butylene glycol, hydrogenated bisphenol A, trimethylolpropane monoaryl ether, neopentyl glycol, 2,2,4-trimethyl-1,3-pentadiol and/or glycerin. In addition, if necessary, a monobasic acid such as acrylic acid, propionic acid or benzoic acid, or a polybasic acid such as trimellitic acid or tetracarboxylic acid of benzol may be further used.

Examples of the type of vinylic monomer may include an alkyl acrylate monomer or an aromatic vinylic monomer. However, it is preferable to use an aromatic vinylic monomer in consideration of reactivity with the unsaturated polyester polymer. For example, as the aromatic vinylic monomer, one or more selected from the group consisting of styrene, α-methylstyrene, p-methylstyrene, vinyl toluene, alkyl styrene substituted with an alkyl group having 1 to 3 carbon atoms, and styrene substituted with a halogen may be used, and preferably, a styrene monomer may be used.

The curing agent may be included for a curing reaction of the binder, and is not particularly limited as long as a curing agent that is used when manufacturing engineered stone is used. The curing agent may be an organic peroxide-based compound or an azo-based compound. The organic peroxide-based compound may be one or two or more selected from a tert-butyl peroxybenzoate thermal curing agent (TBPB, Trigonox C, akzo nobel), diacyl peroxide, hydroperoxide, ketone peroxide, peroxy ester, peroxy ketal, dialkyl peroxide, alkyl perester, percarbonate, and peroxydicarbonate. For example, the compound may be tert-butyl peroxybenzoate thermal curing agent, benzoyl peroxide, dicumyl peroxide, butyl hydroperoxide, cumyl hydroperoxide, methyl ethyl ketone peroxide, t-butyl peroxy maleic acid, t-butyl hydroperoxide, acetyl peroxide, lauroyl peroxide, t-butyl peroxy neodecanoate, or t-amyl peroxy 2-ethyl hexanoate, but is not necessarily limited thereto.

In addition, the azo-based compound may be azobisisobutyronitrile, but is not necessarily limited thereto. The binder resin may include 0.4 to 2.5 parts by weight of the curing agent on the basis of 100 parts by weight of the unsaturated polyester resin. If the curing agent is included in an amount below the above range, it is difficult to cure the binder, and if the curing agent is included in an amount exceeding the above range, discoloration of the binder may occur, and therefore, the curing agent may be included within the above range.

The catalyst may be included to promote curing of the binder at a low temperature, is not particularly limited as long as a catalyst that is used in the manufacture of engineered stone is used, and may be one or two or more selected from cobalt-based, vanadium-based, or manganese-based metal soaps, tertiary amines, quaternary ammonium salts, and mercaptans. For example, a cobalt 6% catalyst (Hex-Cem, Borchers) may be used. The binder resin may include 0.05 to 0.3 part by weight of the catalyst on the basis of 100 parts by weight of the unsaturated polyester resin. If the catalyst is included in an amount below the above range, curing is not promoted, and if the catalyst is included in an amount exceeding the above range, discoloration of the binder may occur, and therefore, the catalyst may be included within the above range.

The coupling agent may be included to improve bonding force between the binder and natural mineral particles, and may be a silane-based or silicate-based coupling agent. The binder resin may include 0.5 to 7 parts by weight of the coupling agent on the basis of 100 parts by weight of the unsaturated polyester resin. If the coupling agent is included in an amount below the above range, the bonding force with the natural mineral particles is reduced, and if the coupling agent is included in an amount exceeding the above range, the cost of the raw material increases, and therefore, the coupling agent may be included within the above range.

Inorganic Particles

The artificial marble and/or the region of the artificial marble of the present invention may include inorganic particles. The inorganic particles of the present invention refer to inorganic particles with a particle size of 0.1 to 4 mm and may be amorphous silica particles, glass particles, crystalline quartz particles, or the like. The particle size may be measured using a particle size analyzer (Beckman Coulter LS 13 320 particle size analyzer).

The inorganic particles of the present invention may be amorphous silica particles. Silica particles are a term commonly used in the field of artificial marble, and generally refer to SiO₂-based inorganic particles having a high SiO₂ content of 90% by weight or more, and including small amounts of other components such as minerals, in addition to SiO₂. The amorphous silica particles of the present invention may be amorphous fused silica particles, and the amorphous silica particles of the present invention may also be referred to as highly transparent amorphous fused silica particles. For the amorphous fused silica particles, amorphous fused silica particles with a particle size of 0.1 to 4 mm may be used. When a region with high transparency is desired, the SiO₂ content of the amorphous silica particles may be 99.5 to 100% by weight, preferably 99.6 to 100% by weight, and more preferably 99.7 to 100% by weight, and an alumina content may be 0.5% by weight or less, preferably 0.4% by weight or less, more preferably 0.3% by weight or less, and even more preferably 0.2% by weight or less. When the SiO₂ content of the amorphous silica particles is 99.5% by weight or more, preferably 99.6% by weight or more, and more preferably 99.7% by weight or more, the transparency of a region where the raw material composition of the artificial marble is cured is further improved.

The SiO₂ content of silica particles and quartz particles of the present invention can be confirmed by quantitatively analyzing the content with XRF (X-Ray Fluorescence spectrometer). In addition, crystalline particles and amorphous particles can be confirmed by XRD (X-ray diffraction), and are generally confirmed by making the particles into pellets and measuring the same.

The inorganic particles of the present invention may be crystalline quartz particles. The crystalline quartz particles of the present invention may be highly transparent crystalline quartz particles or opaque crystalline quartz particles.

The highly transparent crystalline quartz particles may be highly transparent crystalline quartz particles having a particles size of 0.1 to 4 mm, and having an SiO₂ content of 99.5 to 100% by weight, preferably 99.6 to 100% by weight, and more preferably 99.7 to 100% by weight, and an alumina content of 0.5% by weight or less, preferably 0.4% by weight or less, more preferably 0.3% by weight or less, and even more preferably 0.2% by weight or less.

When the SiO₂ content in the highly transparent crystalline quartz particles is less than 99.5% by weight, for example, 99.4% by weight or less, the transparency of the region where the raw material composition of the artificial marble is cured is lowered. Therefore, when a region with high transparency is desired, highly transparent crystalline quartz particles having a SiO₂ content of 99.5% by weight or more may be used.

The opaque crystalline quartz particles may be opaque crystalline quartz particles having a particles size of 0.1 to 4 mm, and having an SiO₂ content of 80.0% by weight or more and less than 99.5% by weight, preferably 85.0% by weight or more and 99.4% by weight or less, and more preferably 90.0% by weight or more and 99.3% by weight or less and an alumina content of 0.5% by weight or less, preferably 0.4% by weight or less, more preferably 0.3% by weight or less, and even more preferably 0.2% by weight or less.

When the SiO₂ content in the opaque crystalline quartz particles is less than 99.5% by weight, for example, 99.4% by weight or less, the transparency of the region where the raw material composition of the artificial marble is cured is lowered. Therefore, when a region with low transparency is desired, opaque crystalline quartz particles having a SiO₂ content of less than 99.5% by weight, preferably 99.4% by weight or less, and more preferably 99.3% by weight or less may be used.

Quartz Powder

The artificial marble and/or the region of the artificial marble of the present invention may include quartz powder. In this case, the quartz powder refers to quartz powder having a particle size of 0.1 mm or less. The particle size may be measured using a particle size analyzer (Beckman Coulter LS 13 320 particle size analyzer).

The quartz powder of the present invention is crystalline quartz powder, and may be highly transparent crystalline quartz powder or opaque crystalline quartz powder.

When a region of an artificial marble with high transparency is desired, crystalline quartz powder with a SiO₂ content of 99.5 to 100% by weight may be used. When a region of an artificial marble with high transparency is desired, the quartz powder may be quartz powder having a SiO₂ content of 99.5 to 100% by weight, preferably 99.6 to 100% by weight, and more preferably 99.7 to 100% by weight, and an alumina content of 0.5% by weight or less, preferably 0.4% by weight or less, more preferably 0.3% by weight or less, and even more preferably 0.2% by weight or less. When a region of an artificial marble with high transparency is desired, the quartz powder is preferably quartz powder having an average SiO₂ of 99.5% by weight or more and 100% by weight or less and an average alumina content of 0.5% by weight or less.

When a region of an artificial marble with high transparency is desired, crystalline quartz powder having a SiO₂ content of 80.0% by weight or more and less than 99.5% by weight may be used. When a region of an artificial marble with low transparency is desired, the quartz powder may be quartz powder having a content of 80.0% by weight or more and less than 99.5% by weight, preferably 85.0% by weight or more and 99.4% by weight or less, and more preferably 90.0% by weight or more and 99.3% by weight or less. When a region of an artificial marble with low transparency is desired, the quartz powder is preferably quartz powder having an average SiO₂ content of less than 99.5% by weight, preferably 99.4% by weight or less, and more preferably 99.3% by weight or less and an average alumina content of 0.5% by weight or less.

The SiO₂ content of quartz powder of the present invention can be confirmed by quantitatively analyzing the content with XRF (X-Ray Fluorescence spectrometer). In this case, the powder is generally made into pellets, which are then measured and confirmed with respect to the content.

Since the quartz powder has a small particle size, self-scattering occurs. Therefore, when it is desired to increase the internal transparency of the region of the artificial marble, crystalline quartz powder having a SiO₂ content of 99.5% by weight or more may be used.

Pigment

The artificial marble and/or the region of the artificial marble of the present invention may include a pigment. The pigment may be, for example, TiO₂, NiO·Sb₂O₃·20TiO₂, Fe₂O₃, Fe₃O₄ etc., and is not particularly limited as long as it is a pigment that is used in the manufacture of an artificial marble.

<Artificial Marble>

The present invention relates to an artificial marble including a pattern region and a base region manufactured by the manufacturing method of an artificial marble of the present invention. The pattern region is a region formed by curing the pattern forming composition, and the base region is a region formed by curing the base composition.

The artificial marble of the present invention includes a pattern region where the pattern forming composition is cured on a surface of the artificial marble. The pattern region may have various shapes according to the shapes of the pattern mold and the screening mask. For example, the artificial marble of the present invention may include a pattern region having a stripe shape on the surface of the artificial marble. In this case, the pattern region may have a stripe shape on the surface of the artificial marble.

A thickness of the pattern region may be equal to or smaller than the thickness of the artificial marble. The thickness of the pattern region may be 1% or greater and 100% or less of the thickness of the artificial marble, preferably 10% or greater, more preferably 30% or greater, and even more preferably 50% or greater.

The artificial marble of the present invention may include a pattern region with a width of 5 mm or greater and 50 mm or less, a pattern region with a width of 5 mm or greater and 40 mm or less, and a pattern region with a width of 5 mm or greater and 30 mm or less. Preferably, the artificial marble of the present invention may include a pattern region with a width of 5 mm or greater and 20 mm or less. However, it will be apparent that the width of the pattern region can be made to be less than 5 mm or greater than 50 mm by adjusting the width of the opening of the screening mask and the width of the convex portion of the pattern mold. That is, the thickness and width of the pattern region can be adjusted by adjusting the shape of the pattern mold. For example, the artificial marble of the present invention can be manufactured by adjusting the shapes of the screening mask and the pattern mold of the present invention, so that an artificial marble having a desired width and depth of the pattern region can be manufactured and the boundary between the pattern region and the base region is clear and can be sharp and straight. In particular, the artificial marble of the present invention may have a clearer boundary between the pattern region and the base region than an artificial marble manufactured by cutting a base composition with a knife to form a groove, putting a pattern forming composition into the groove, and then curing the pattern forming composition.

The advantages and features of the present invention, and a method for achieving the same will become apparent with reference to the examples described below in detail. However, the present invention is not limited to the examples disclosed below, but can be implemented in a variety of different forms. The examples are provided to only complete the disclosure of the present invention and to allow one skilled in the art to completely understand the category of the present invention. The present disclosure is defined by the category of the claims.

<Materials and Methods>

For the highly transparent crystalline quartz particles, highly transparent crystalline quartz particles having a particle size of 0.1 to 2.5 mm were used. In addition, the highly transparent crystalline quartz particles are quartz having a SiO₂ content of 99.7% by weight or more and 100% by weight or less and a crystallinity of 100%.

For the highly transparent amorphous fused silica particles, highly transparent amorphous fused silica particles having a particle size of 0.1 to 2.5 mm were used. In addition, the highly transparent amorphous fused silica particles have a SiO₂ content of 99.7% by weight or more and 100% by weight or less, and an average SiO₂ content of 99.7% by weight.

For the highly transparent crystalline quartz powder, highly transparent crystalline quartz powder having a particle size of 0.1 mm or smaller in diameter was used. In addition, the highly transparent crystalline quartz powder has an alumina content of 0.5% by weight or less. In this experiment, several types of quartz powders were used according to the SiO₂ content.

That is, highly transparent crystalline quartz powder having a SiO₂ content of 99.7% by weight or more and 100% by weight or less and an average SiO₂ content of 99.7% by weight, and transparent crystalline quartz powder having a SiO₂ content is 99.4% by weight or more and less than 99.5% by weight and an average SiO₂ content of 99.4% by weight were used.

The binder resin composition was manufactured as follows. An unsaturated polyester resin in which an unsaturated polyester polymer obtained by polycondensation of ortho-phthalic acid with a polyhydric alcohol and a styrene monomer were used in a weight ratio of 65:35 was used. Then, a binder resin composition was manufactured by mixing and dispersing 1.5 parts by weight of a tert-butyl peroxybenzoate thermal curing agent (TBPB, Trigonox C, akzo nobel) serving as a curing agent, 0.1 part by weight of a cobalt 6% catalyst (Hex-Cem, Borchers) serving as a catalyst and 3 parts by weight of a silane-based coupling agent on the basis of 100 parts by weight of the unsaturated polyester resin.

For the pigment, TiO₂, NiO·Sb₂O₃·20TiO₂, Fe₂O₃, Fe₃O₄, etc., which are pigments used when manufacturing artificial marbles, were used. Pigments used in each of the Manufacture Examples may be different, which is intended to only produce various colors and does not significantly affect the physical properties of artificial marble.

For the pattern mold, a pattern mold including a plurality of convex portions, the length (d) of the convex portion being 15 and the width (1) of the convex portion being 10 to 18 mm, was used. For the screening mask, a screening mask including a plurality of openings corresponding to the convex portions of the pattern mold, protrusions having a length of 10 mm, and a flat plate portion having a thickness of 3 mm was used. In this case, the width of the opening was 0.5 to 1 mm wider than that of the corresponding convex portion.

### Manufacture Example 1

The highly transparent amorphous fused silica particles were added and mixed well in the binder resin composition by using the planetary mixer. Then, the highly transparent crystalline quartz powder and the pigment were added and mixed well in the mixture to manufacture a mixture. The mixture was put on a conveyor belt, and while the belt was being moved, pulverized pigments were dropped from a height of about 30 cm from the conveyor belt and put into the mixture to manufacture a raw material composition of an artificial marble.

In this case, 600 parts by weight of the highly transparent amorphous fused silica particles having an average SiO₂ content of 99.7% by weight, 300 parts by weight of the highly transparent crystalline quartz powder having an average SiO₂ content of 99.7% by weight and 3 parts by weight of the pigment were used on the basis of 100 parts by weight of the binder resin composition.

### Manufacture Example 2

A raw material composition of an artificial marble was manufactured in the same manner as in Manufacture Example 1, except that highly transparent crystalline quartz particles having an average SiO₂ content of 99.7% by weight were used instead of the highly transparent amorphous fused silica particles in Comparative Manufacture 1.

### Manufacture Example 3

A raw material composition of an artificial marble was manufactured in the same manner as in Manufacture Example 1, except that transparent crystalline quartz powder having an average SiO₂ content of 99.4% by weight was used instead of the highly transparent crystalline quartz powder having an average SiO₂ content of 99.7% by weight in Manufacture Example 1.

That is, the weight ratios of the materials used in the raw material compositions of an artificial marble in Manufacture Examples 1 to 3 are as follows (Table 1). In Table 1, the SiO₂ content is an average value of SiO₂ contents in particles or powder.

TABLE 1

| | | inorganic particles | | powder | |
|---|---|---|---|---|---|
| | | Highly | Highly | Highly | |
| | | transparent | transparent | transparent | Transparent |
| | | amorphous | crystalline | crystalline | crystalline |
| | Binder | fused silica | quartz | quartz | quartz |
| | resin | particles | particles | powder | powder |
| | composition | (SiO₂ 99.7%) | (SiO₂ 99.7%) | (SiO₂ 99.7%) | (SiO₂ 99.4%) |
| Manufacture | 100 parts | 600 parts | | 300 parts | |
| Example 1 | by weight | by weight | | by weight | |
| Manufacture | 100 parts | | 600 parts | 300 parts | |
| Example 2 | by weight | | by weight | by weight | |
| Manufacture | 100 parts | 600 parts | | | 300 parts |
| Example 3 | by weight | by weight | | | by weight |

### Example 1

The raw material composition of an artificial marble in Manufacture Example 3 was used as a base composition, and the raw material composition of an artificial marble in Manufacture Example 1 was used as a pattern forming composition.

First, the base composition was distributed, i.e., put into a rubber mold. A screening mask and a pattern mold were placed on the base composition and the pattern mold was pressed to compress the base composition. After the base composition was compressed, the pattern mold was removed. Thereafter, the pattern forming composition was put onto the screening mask, and the pattern forming composition was put into grooves formed as the pattern mold was removed. The screening mask was then removed, allowing the pattern forming composition to be located in the grooves without intruding into the base composition. Then, the mold was put into a vibration-compression-vacuum process, and a vibration-compression-vacuum process was performed for 2 minutes under a vacuum atmosphere of 10 mbar and a vibration condition of 2700 rpm. Then, the composition was subjected to curing at 120° C. for 1 hour, cooled to room temperature after the curing was completed, and then taken out of the mold to manufacture an artificial marble. After cutting the artificial marble on all sides, the surface was polished smoothly to manufacture an artificial marble sample.

As a result of measurement on the upper surface of the artificial marble manufactured in Example 1, it could be confirmed that 50% or more of the vein pattern had a width of 5 mm to 50 mm and that in a cross section including a maximum thickness of the vein pattern among cross sections in a direction perpendicular to a plate surface of the artificial marble, a thickness of the vein pattern was 10% or greater of a total thickness of the artificial marble (FIG. 16).

### Example 2

The raw material composition of an artificial marble in Manufacture Example 1 and the raw material composition of an artificial marble in Manufacture Example 2 were mixed in a weight ratio of 1:3 to manufacture a raw material composition of an artificial marble, which was used as a base composition. In this case, the raw material composition of an artificial marble in Manufacture Example 1 and the raw material composition of an artificial marble in Manufacture Example 2 each included different pigments, and were incompletely mixed so that the raw material compositions of an artificial marble in Manufacture Example 1 and Manufacture Example 2 were not completely mixed with each other and the raw material compositions of an artificial marble in Manufacture Example 1 and Manufacture Example 2 each remained lumped in places in the final base compositions, respectively.

An artificial marble sample was manufactured in the same manner as in Example 1, except that the base composition mixed in this manner was used and the raw material composition of an artificial marble in Manufacture Example 3 was used as the pattern forming composition.

### Example 3

An artificial marble sample was manufactured in the same manner as in Example 1, except that a screening mask without protrusions was used.

### Comparative Example 1

The raw material composition of an artificial marble in Manufacture Example 1 was used as a base composition, and the raw material composition of an artificial marble in Manufacture Example 3 was used as a pattern forming composition.

First, the base composition was distributed, i.e., put into a rubber mold. The surface of the base composition corresponding to the same vein region as in Example 1 was dug out to make cracked grooves. The pattern forming composition was put into the grooves. (Digging-Filling method) After that, the mold was put into a vibration-compression-vacuum process, and a vibration-compression-vacuum process was performed for 2 minutes under a vacuum atmosphere of 10 mbar and a vibration condition of 2700 rpm. Then, the composition was subjected to curing at 120° C. for 1 hour, cooled to the room temperature after the curing was completed, and then taken out of the mold to manufacture an artificial marble. After cutting the artificial marble on all sides, the surface was polished smoothly to manufacture an artificial marble sample.

### Comparative Example 2

The raw material composition of an artificial marble in Manufacture Example 3 was used as a base composition, and the raw material composition of an artificial marble in Manufacture Example 1 was used as a pattern forming composition.

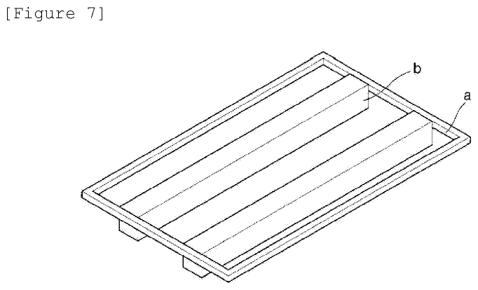

Meanwhile, as shown in FIG. 7, an insert mold (a) having a rectangular shape and including a plurality of internal insert portions (b) extending from one edge of the rectangle to the facing edge was prepared. A thickness of the insert portion was greater than a thickness of the edge of the insert mold, and a width of the insert portion was 15 cm.

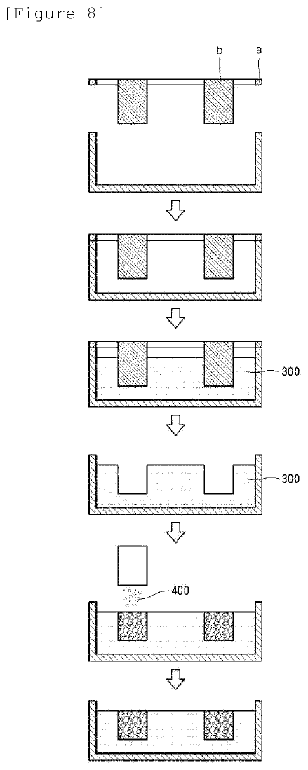

The insert mold was placed on a rubber mold so that the edge of the insert mold was over the rubber mold and the insert portions were located within the rubber mold. Then, the base composition 300 was distributed, i.e., put into the insert mold and the rubber mold, so that the base composition was put into the rubber mold. Then, when the insert mold was removed, a plurality of long grooves were formed at the places where the insert portions were, and the base composition next to the grooves partially flowed into the grooves. The pattern forming composition 400 was put into the plurality of grooves (FIG. 8). Then, the mold was put into a vibration-compression-vacuum process, and a vibration-compression-vacuum process was performed for 2 minutes under a vacuum atmosphere of 10 mbar and a vibration condition of 2700 rpm. Then, the composition was subjected to curing at 120° C. for 1 hour, cooled to room temperature after the curing was completed, and then taken out of the mold to manufacture an artificial marble. After cutting the artificial marble on all sides, the surface was polished smoothly to manufacture an artificial marble sample.

### Comparative Example 3

An artificial marble sample was prepared in the same manner as in Example 1, except that the screening mask was not used.

That is, the raw material composition of an artificial marble in Manufacture Example 3 was used as a base composition, and the raw material composition of an artificial marble in Manufacture Example 1 was used as a pattern forming composition.

First, the base composition was distributed, i.e., put into a rubber mold. A pattern mold was placed on the base composition and the pattern mold was pressed to compress the base composition. After the base composition was compressed, the pattern mold was removed. Thereafter, the pattern forming composition was put into so that the pattern forming composition was put into the grooves formed as the pattern mold was removed. Then, the mold was put into a vibration-compression-vacuum process, and a vibration-compression-vacuum process was performed for 2 minutes under a vacuum atmosphere of 10 mbar and a vibration condition of 2700 rpm. Then, the composition was subjected to curing at 120° C. for 1 hour, cooled to room temperature after the curing was completed, and then taken out of the mold to manufacture an artificial marble. After cutting the artificial marble on all sides, the surface was polished smoothly to manufacture an artificial marble sample.

In Examples 1 to 3 and Comparative Examples 1 to 3, after manufacturing the artificial marble having a thickness of 18 mm, the upper and lower portions were each polished by about 1 to 2 mm to complete the final artificial marble having a thickness of 15 mm.

### Experimental Example 1

The artificial marble samples in Examples 1 to 3 and Comparative Examples 1 to 3 were observed with the naked eye.

As a result, in the artificial marble samples of Examples 1 to 3, the boundary between the base region and the pattern region was clear and straight, and the width of the pattern was about 10 to 18 mm.

However, in the artificial marble sample of Comparative Example 1, the boundary between the base region and the pattern region was not clear and it was difficult to measure the pattern region, making it difficult to define the width of the pattern. This is because the digging-filling method was used when forming the pattern in Comparative Example 1, so a portion of the pattern region was intruded by the collapsed base material to make the boundary blurry. In addition, it was determined that the base composition was subjected to the vibration-compression-vacuum process without being compacted and the base and vein pattern compositions that were not sufficiently compacted were mixed with each other, so that the boundary between the base region and the pattern region was not clear.

In the artificial marble samples of Comparative Examples 2 and 3, the boundary between the base region and the pattern region was also not clear. The reasons are as follows. In the case of Comparative Example 2, it was determined that the base composition flowed into the grooves formed as the insert mold was removed and the pattern forming composition fell on the base composition while the pattern forming composition was put into the grooves.

In the case of Comparative Example 3, the effect of collapsing the pattern was relatively insignificant, but while the pattern forming composition was put into the grooves formed after the pattern mold was removed, the pattern forming composition also fell on the base composition. Even after final sanding (a process of adjusting the thickness and improving the surface characteristics while grinding the surface) was performed, it was determined that the boundary between the base region and the pattern region was not clear after the curing into the artificial marble due to the vein forming composition component partially left in the base region.

### Experimental Example 2

The manufacturing process of the artificial marble samples of Example 1 and Comparative Example 1 was recorded with photographs according to the process.

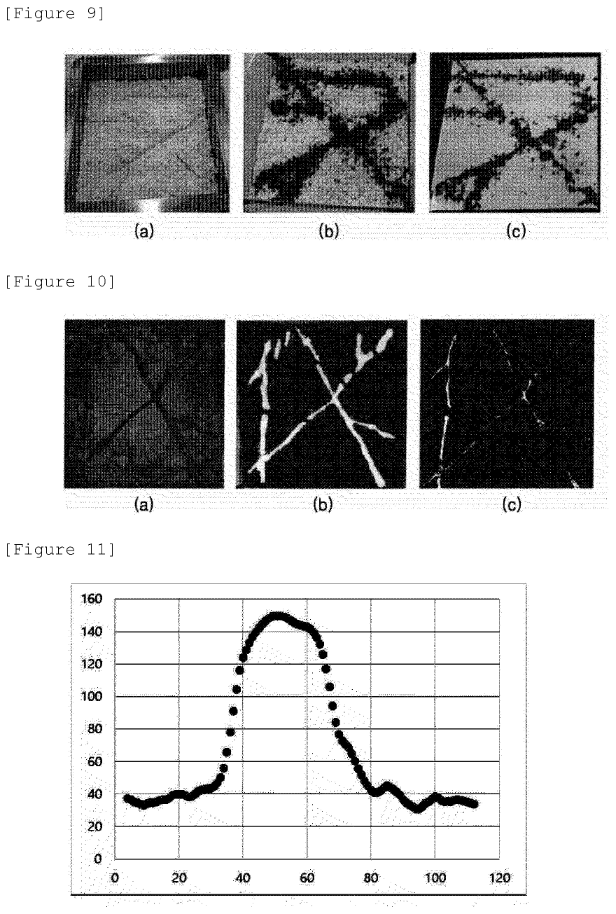

FIG. 9 shows a manufacturing process of an artificial marble sample of Comparative Example 1. The base composition put into the mold was removed to form grooves (a), the pattern forming composition was put into the grooves (b), and the composition was then cured to manufacture an artificial marble (c).

FIG. 10 shows a manufacturing process of an artificial marble sample of Example 1. The base composition put into the mold was formed with grooves by using a pattern mold and a screening mask and the pattern mold was removed (a), the pattern forming composition was put into the grooves (b), and then the screening mask was removed and the composition was cured to manufacture an artificial marble (c).

### Experimental Example 3

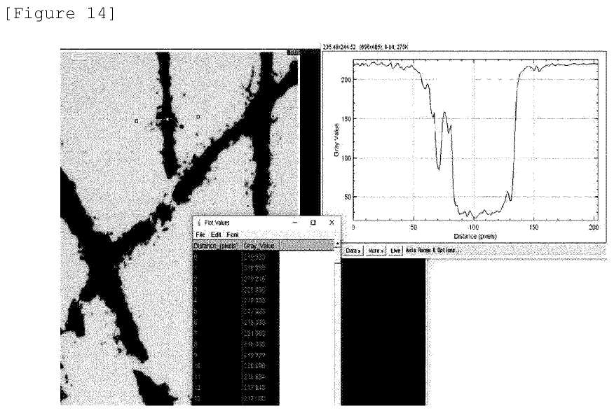

On the artificial marble manufactured in Example 1 and the artificial marble for comparison, as shown in FIGS. 13 and 14, a straight line traversing the vein pattern in the width direction and having both ends located on the base was drawn, the gray value was measured along the straight line, and 5-section moving average values were obtained and were shown in the graphs of FIGS. 11 and 12. In FIG. 13, the boundary of the pattern was clear at the portions where the value was measured, and therefore, only one peak appeared in FIG. 11. In FIG. 14, the boundary of the pattern was not clear at the portions where the value was measured, and therefore, two peaks protruding downward were observed in FIG. 12.

### Experimental Example 4

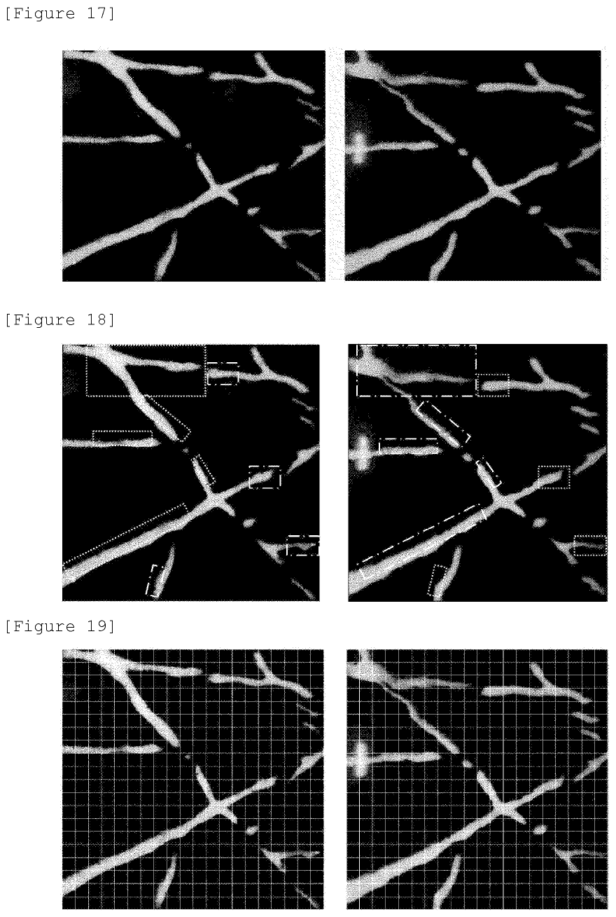

A region of 30 cm×30 cm on each of the upper surfaces of the artificial marbles manufactured in Example 1 (left photograph) and Comparative Example 3 (right photograph) is shown in FIG. 17. In FIG. 18, among the vein patterns appearing on the upper surface of the artificial marble, a part having a clear boundary with a base is shown with a short dotted line and a part having a disordered boundary is shown with a long dotted line, which are readily discriminated with the naked eye. It can be confirmed that there were many neat areas in Example 1 in which the screening mask was applied.

FIG. 19 shows 20×20 divided surfaces of the photograph of FIG. 17. In the artificial marble (left photograph) of Example 1, virtual straight lines were drawn for 139 divided surfaces, except 261 divided surfaces where only the base or vein pattern was present among the total 400 divided surfaces, the gray value was measured along the straight lines, and the 5-section moving average values were obtained. In the artificial marble of Comparative Example 1 (right photograph), virtual straight lines were drawn for 141 divided surfaces, except 258 divided surfaces where only the base or vein pattern was present among the total 400 divided surfaces, the gray value was measured along the straight lines, and the 5-section moving average values were obtained. The virtual straight line is a straight line traversing the vein pattern in the width direction and having both ends located on the base, or when it is impossible to draw a straight line having both ends located on the base, a straight line having one end located on the base and the other end located on the vein pattern.

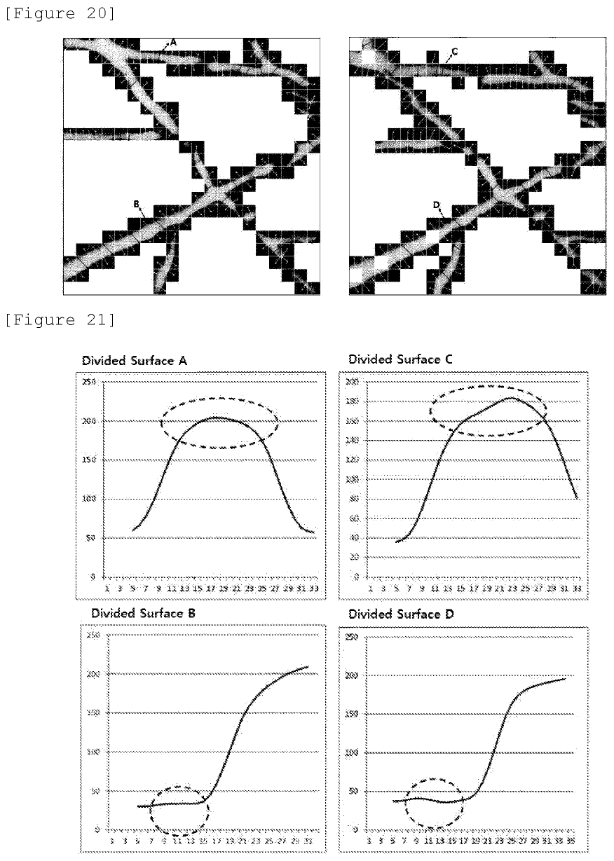

FIG. 20 shows virtual lines drawn on effective divided surfaces excluding divided surfaces where only the base or vein pattern is present. The graphs of 5-section moving average values of the gray value measured along the virtual straight lines on the divided surfaces A and B among the divided surfaces of the artificial marble (left photograph) of Example 1 and on the divided surfaces C and D among the divided surfaces of the artificial marble (right photograph) of Comparative Example 3 are shown in FIG. 21. Only one peak appeared on the divided surfaces A and B, but two peaks corresponding to the inflection points appeared on the divided surfaces C and D.

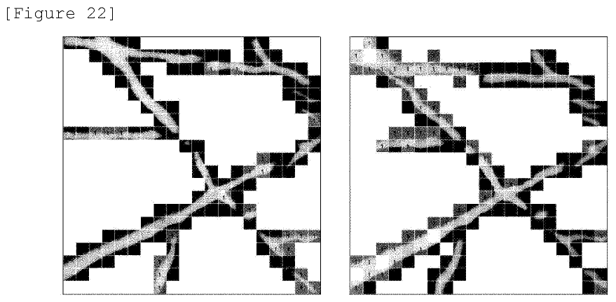

In FIG. 22, among the effective divided surfaces, a divided surface on which two or more peaks appear as described above is marked with 1. In the artificial marble of Example 1 (left photograph), two peaks appeared on the 23 divided surfaces of the 139 effective divided surfaces, so the ratio was 17%. In the artificial marble of Comparative Example 3 (left photograph), two peaks appeared on the 50 divided surfaces of the 141 effective divided surfaces, so the ratio was 35%. The divided surface where the two peaks appeared indicates a portion where the pattern was spread.

1. An engineered stone artificial marble comprising a base and a pattern provided in the base,
wherein the pattern comprises a vein pattern,
50% or more of the vein pattern has a width of 5 mm to 50 mm on a surface where the vein pattern is most present of surfaces of the artificial marble, and
wherein in a cross section including a maximum thickness of the vein pattern among cross sections in a direction perpendicular to a plate surface of the artificial marble, an area of the vein pattern in which a thickness of the vein pattern is 10% or greater of a total thickness of the artificial marble is 50% or greater of an area of the entire pattern.

2. The artificial marble of claim 1, wherein 80% or more of the vein pattern has a width of 5 mm to 50 mm on the surface where the vein pattern is most present among the surfaces of the artificial marble.

3. The artificial marble of claim 1, wherein 80% or more of the vein pattern has a width of 5 mm to 20 mm on the surface where the vein pattern is most present among the surfaces of the artificial marble.

4. The artificial marble of claim 1, wherein the surface where the vein pattern is most present among the surfaces of the artificial marble comprises a vein pattern having a continuous length of 50 mm or longer.

5. The artificial marble of claim 1, wherein in a cross section comprising a maximum thickness of the vein pattern among cross sections in a direction perpendicular to a plate surface of the artificial marble, an area of the vein pattern in which a thickness of the vein pattern is 30% or greater of a total thickness of the artificial marble is 50% or greater of an area of the entire pattern.

6. The artificial marble of claim 1, wherein the base and the vein pattern are not substantially mixed.

7. An engineered stone artificial marble comprising a base and a pattern provided in the base,
wherein the pattern comprises a vein pattern, and
wherein when an arbitrary square region is equally divided into 20×20 surfaces on a surface where the vein pattern is most present among surfaces of the artificial marble and then a straight line traversing the vein pattern in a width direction and having both ends located on the base is drawn, or if it is not possible to draw a straight line whose both ends are located on the base, a straight line with one end on the base and the other end on the vein pattern is drawn, an area of divided surfaces having a vein pattern having two or more peaks on a graph of 5-section moving average values of a gray value measured along the straight line is less than 30% of an area excluding the divided surfaces, on which only the vein pattern is present or only the base is present, in the square region.

8. An engineered stone artificial marble comprising:
a first region formed by first distribution on a surface; and
a second region formed by second distribution after the first distribution,
wherein the first region and the second region are different in composition from each other, and the first region and the second region are not substantially mixed.

9. The artificial marble of claim 8, wherein the composition comprises at least one of types of compounds included in the first and second regions, a size of a particle, a distribution of constituent particles, an additive, chromaticity, or a sense of color.

10. A screening mask comprising a flat plate portion and one or more openings.

11. The screening mask of claim 10, further comprising a protrusion protruding from an edge of each of the openings along a shape of the opening.

12. A pattern mold comprising a concave portion and one or more convex portions,
wherein the convex portions correspond to the openings of the screening mask of claim 10 and are insertable into the openings.

13. The pattern mold of claim 12, wherein a width of each of the convex portions is equal to or smaller than a width of the opening.

14. A manufacturing method of an artificial marble comprising:
molding a base composition into a mold;
placing a screening mask and a pattern mold over the base composition, the screening mask including a flat plate portion and one or more openings, the pattern mold including a concave portion and one or more convex portions, the convex portions corresponding to the openings of the screening mask and being insertable into the openings;
pressing the pattern mold to compress the base composition;
removing the pattern mold to form one or more grooves in the base composition;
putting a pattern forming composition into the grooves and removing the screening mask;
manufacturing an artificial marble flat plate by compressing the composition in the mold while applying vacuum and vibration to the composition; and
applying heat to the artificial marble flat plate before curing, and curing the artificial marble flat plate.

15. The manufacturing method of an artificial marble of claim 14, wherein the screening mask comprises a flat plate portion and one or more openings, and
wherein the pattern mold comprises a concave portion and one or more convex portions, and the convex portions correspond to the openings and are insertable into the openings.

16. The manufacturing method of an artificial marble of claim 14, wherein the artificial marble comprises a pattern region on a surface of the artificial marble, in which a pattern forming composition is cured.

17. The manufacturing method of an artificial marble of claim 16, wherein the pattern region comprises a vein pattern.

18. The manufacturing method of an artificial marble of claim 14, wherein a width of each of the convex portions is 5 mm or greater and 50 mm or less.

19. The manufacturing method of an artificial marble of claim 14, wherein the screening mask further comprises a protrusion, and a length of the protrusion is 1 to 100% of a thickness of the artificial marble.

20. The manufacturing method of an artificial marble of claim 14, wherein the artificial marble comprises a pattern region in which a pattern forming composition is cured, and a thickness of the pattern region is 10% or greater of a thickness of the artificial marble.

21. The manufacturing method of an artificial marble of claim 14, wherein the artificial marble comprises a pattern region in which a pattern forming composition is cured, and
wherein a thickness and width of the pattern region are able to be adjusted by adjusting a shape of the pattern mold.

22. An artificial marble comprising a pattern region and a base region and manufactured by the manufacturing method of an artificial marble of claim 14.

23. The artificial marble of claim 22, wherein the artificial marble comprises a pattern region having a width of 5 mm or greater and 50 mm or less on a surface of the artificial marble.

24. The artificial marble of claim 22, wherein the artificial marble has a clearer boundary between the pattern region and the base region than an artificial marble manufactured by cutting a base composition with a knife to form a groove, putting a pattern forming composition into the groove, and then curing the pattern forming composition.
